(19) United States
(12) Patent Application Publication
(10) Pub. No.: US 2008/0044309 A1
(43) Pub. Date: Feb. 21, 2008

(54) Liquid Chromatograph

(75) Inventors: Kazuko Yamashita, Osaka (JP); Masahiko Okamoto, Osaka (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/718,073

(22) PCT Filed: Oct. 20, 2005
(86) PCT No.: PCT/JP05/19325

§ 371 Date: Aug. 13, 2007

(30) Foreign Application Priority Data
Oct. 26, 2004 (JP) 2004-310673

(51) Int. Cl. G01N 30/46; G01N 30/06; G01N 30/62; G01N 30/78; G01N 30/74; G01N 30/08

(52) U.S. Cl. 422/52

(57) ABSTRACT

A liquid chromatograph, comprising a first analysis column, which separates a component in a sample guided by a first mobile phase; first detection device for detection of the component; a fractionation flow path, which fractionates and holds in an isolation portion the component detected by the first detection device; a trap flow path, which sends the component held in the isolation portion into a trap column, and causes capture and concentration of the component in the trap column; a second analysis column, which separates the component which has been captured and concentrated in the trap column and is eluted from the trap column by a second mobile phase; and second detection device for detection of the component separated in the second analysis column, wherein the first and second detection devices have a detector selected from a group consisting of a photodiode array detector, an infrared detector, a radioisotope detector, and a fluorescence detector.

### TECHNICAL FIELD

This invention relates to a liquid chromatograph.

### BACKGROUND ART

Liquid chromatographs are known in which a component in a sample comprising a plurality of components is separated by a first analysis column, the component is detected by a first ultraviolet light detector (hereafter abbreviated “UV detector”), the component is captured and concentrated in a trap column, this is sent to a second analysis column and separated, and detection is performed by a second UV detector (see for example Patent References 1 and 2).

In such a liquid chromatograph, UV detectors are used, and so an extremely large number of compounds having absorption in the ultraviolet region can be taken to be components for concentration; moreover, because detection sensitivity is high, even when the component for concentration is minute, a concentration operation can be performed, and in the second analysis column high-sensitivity analysis is possible.

However, when the types of the first analysis column and the second analysis column as well as the compositions of the mobile phases therein are different, the holding times of the component detected by the first UV detector and the component detected by the second UV detector are different, and so it has been difficult to reliably identify the component as being the same in each. Further, because of the high sensitivity, for example background components, contaminant components, components remaining in the fractionation flow path, and other components not intended for concentration may also be detected by the second UV detector, and it has been difficult to determine which component is the target component for concentration. Further, depending on the target component for concentration, the component may not be captured in the trap column; in such cases, the component detected by the second UV detector may be incorrectly identified as the target component for concentration.

Patent Reference 1: Japanese Patent No. 2892795

Patent Reference 2: International Publication WO99/61905

### DISCLOSURE OF THE INVENTION

### Problems to be Solved by the Invention

In light of such circumstances, these inventors performed studies for the purpose of developing a liquid chromatograph enabling simple and reliable judgment that a component separated and concentrated in a first analysis column is the same as a component separated in a second analysis column, and discovered that by using, as the first and second detection devices, a photodiode array detector, an infrared light detector, a radioisotope detector, or a fluorescence detector, it is possible to simply and reliably judge that a target component separated and concentrated in the first analysis column and a component separated in the second analysis column are the same, without any influence from background components, contaminant components, components remaining in the fractionation flow path, or similar.

### Means to Solve the Problems

In this invention, a liquid chromatograph is provided, comprising a first analysis column, which separates a component in a sample guided by means of a first mobile phase; first detection device, which detects the component; a fractionation flow path, which fractionates and holds in an isolation portion the component detected by the first detection device; a trapping flow path, which sends the component held in the isolation portion to a trap column, and captures and concentrates the component in the trap column; a second analysis column, which separates the component which has been captured and concentrated in the trap column and is eluted from the trap column by a second mobile phase; and second detection device, which detects the component separated in the second analysis column, wherein the first and second detection devices have a detector selected from a group consisting of a photodiode array detector, an infrared light detector, a radioisotope detector, and a fluorescence detector. In particular, it is preferable that the first and second detection devices have the same detector, selected from a group consisting of a photodiode array detector, an infrared light detector, a radioisotope detector, and a fluorescence detector.

It is preferable that a plurality of trap columns be provided, and that a flow path switching mechanism be further comprised for simultaneously performing a capture/concentration operation of causing capture and concentration of the component in one of the trap columns of the trap flow path, and an elution operation of causing elution of the trapped component from another trap column.

Further, it is preferable that the first and second detection devices each further have an ultraviolet light detector.

Further, it is preferable that the component held by the isolation portion be sent to the trap column while being diluted by a diluent.

Further, it is preferable that the liquid chromatograph of the above Item 1 or Item 2 fractionates the component separated in the first analysis column, and holds the component in the isolation portion together with a diluent.

### ADVANTAGEOUS RESULTS OF THE INVENTION

A liquid chromatograph of this invention employs, as first and second detection devices, photodiode array detectors, infrared detectors, radioisotope detectors, or fluorescence detectors, and so it is possible to simply and reliably judge that a target component detected by the first detection device and a component detected by the second detection device are the same, without any influence from background components, contaminant components, components remaining in the fractionation flow path, or similar.

### BRIEF DESCRIPTION OF THE DRAWINGS

FIG. 1 is a diagram showing the liquid chromatograph of one aspect of the invention and the operation thereof, showing a state in which a process of separating a component in a sample and a process of fractionation of the separated component are being performed.

FIG. 2 is a diagram showing a liquid chromatograph and operation thereof which is one aspect of the invention, showing a state in which a process of capturing and concentrating of a component in a trap column is being performed.

FIG. 3 is a diagram showing a liquid chromatograph and operation thereof which is one aspect of the invention, showing a state in which a process of analyzing a component, captured and concentrated in a trap column, in a second analysis column.

FIG. 4 is a diagram showing a liquid chromatograph and operation thereof in another aspect of the invention, showing a state in which separation of a component in a sample and fractionation of the separated component are being performed.

FIG. 5 is a diagram showing a liquid chromatograph and operation thereof in another aspect of the invention, showing a state in which a process of capture and concentration of a component in a trap column and elution of the concentrated component, and a process of analysis of the component in the second analysis column, are being performed simultaneously.

FIG. 6 is a diagram showing a liquid chromatograph and operation thereof in another aspect of the invention, showing a state in which another process of capture and concentration of a component in a trap column, and a process of elution of the component captured and concentrated in a trap column and analysis in a second analysis column, are being performed simultaneously.

FIG. 7 is a diagram showing a liquid chromatograph and operation thereof in another aspect of the invention, showing a state in which a process of separation of the component in the sample and fractionation of the separated component is being performed.

FIG. 8 is a diagram showing a liquid chromatograph and operation thereof in another aspect of the invention, showing a state in which a process of capture and concentration of the component in a trap column and elution of the concentrated component, and a process of analysis of the component in a second analysis column, are being performed simultaneously.

FIG. 9 is a diagram showing a liquid chromatograph and operation thereof in another aspect of the invention, showing a state in which a process of capture and concentration of the component in a trap column, and a process of elution of the component captured and concentrated in the trap column and of analysis in a second analysis column, are being performed simultaneously.

### EXPLANATION OF SYMBOLS

2a, 2b, 36a, 36b Liquid pump
4a Organic solvent comprised by first mobile phase
4b Water comprised by first mobile phase
6a Diluent
6b Carrier liquid
8, 39 Online degasser
10, 12, 22, 28a, 28b Switching valve
14, 40 Mixer
16 Auto-sampler
18 First analysis column
20 PDA detector
20a UV detector
20b IR detector
24 Fractionation flow path
25a-25e Isolation portion
26a, 26b Distribution valve
30, 30a, 30b Trap column
32 Second analysis column
33 PDA detector
33a UV detector
33b IR detector
38a Organic solvent comprised by second mobile phase
38b Water comprised by second mobile phase
41 Column oven
L1-L17, L22-L23 Flow path

### BEST MODES FOR CARRYING OUT THE INVENTION

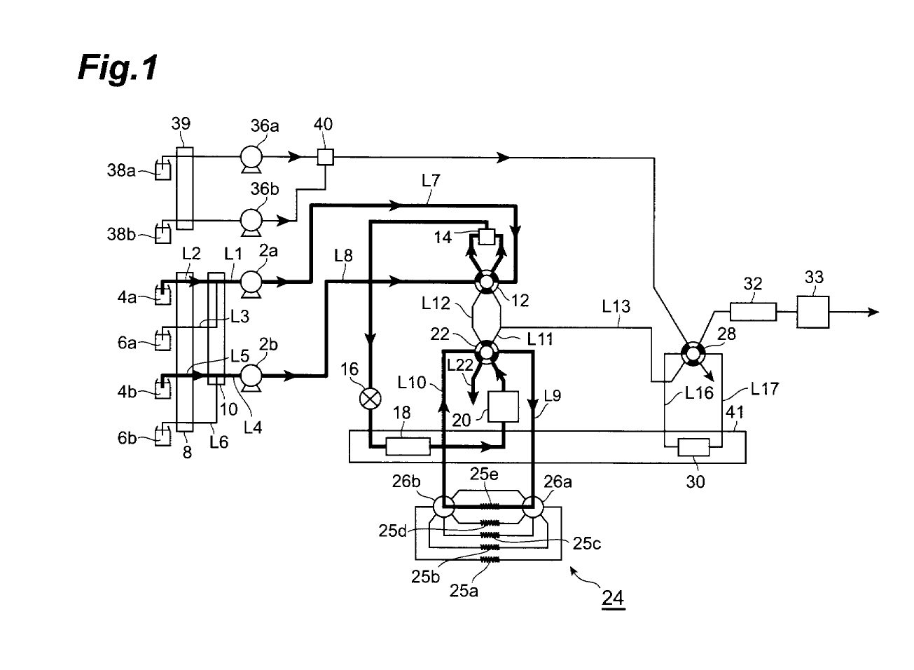

Below, the invention is explained in detail, referring to the drawings. FIG. 1 shows one aspect of a liquid chromatograph of the invention. The liquid chromatograph shown in FIG. 1 is a liquid chromatograph using, as first and second detection devices, photodiode array detectors (hereafter abbreviated to “PDA detectors”), and comprising one trap column.

The liquid pumps 2a and 2b may be any pumps capable of sending a solvent, such as an organic solvent, water, or similar, which can be used as a mobile phase. It is preferable that it be possible to set such pumps to arbitrary flow rates.

On the upstream side of the liquid pump 2a, a switching valve 10 is connected by a flow path L1, and the switching valve 10 and the organic solvent 4a comprised by the first mobile phase are connected by the flow path L2. Midway in the flow path L2 is provided an online degasser 8. The online degasser 8 has a function of preventing inclusion of air bubbles in the organic solvent 4a and diluent 6a flowing in the flow path; it is preferable that the online degasser 8 be provided in order to maintain a stable liquid flow state. The switching valve 10 is connected to the diluent 6a by the flow path L3. By switching the switching valve 10, flow path L1 and flow path L2 can be connected, and flow path L1 and flow path L3 can be connected.

Similarly, on the upstream side of the liquid pump 2b, a switching valve 10 is connected by a flow path L4, and the switching valve 10 and water 4b comprised by the first mobile phase are connected by a flow path L5, while the switching valve 10 and carrier liquid 6b are connected by a flow path L6. Further, midway in the flow paths L5 and L6 is provided an online degasser 8. By switching the switching valve 10, the flow paths L4 and L5 are connected, or the flow paths L4 and L6 are connected. In the aspect shown in FIG. 1, the organic solvent 4a and diluent 6a comprised by the first mobile phase are sent by the liquid pump 2a via the switching valve 10; but liquid pumps which send the respective liquids may be provided without the intervention of a switching valve 10. Similarly for the water 4b and carrier liquid 6b comprised by the first mobile phase, liquid pumps may be provided to send the respective liquids without the intervention of a switching valve 10.

The diluent 6a is a liquid which dilutes the component pressed out from the isolation portions 25a to 25e, described below, while sending the component into the trap column 30; the carrier liquid 6b is liquid which presses the component held in the isolation portions 25a to 25e, described below, into the trap column 30; these may employ the same solvent, or a different solvent, but it is preferable that a solvent be selected so as to heighten the efficiency of adsorption of the component to the trap column 30, according to the organic solvent 4a and water 4b comprised by the first mobile phase, the component, and similar. As the diluent 6a and carrier liquid 6b, water or an aqueous solution not comprising a nonvolatile salt or other buffer can also be used. When using a first mobile phase comprising a buffer, by using a carrier liquid not comprising this buffer, desalination processing can be performed when capturing and concentrating the component in the trap column.

The flow paths L7 and L8 on the downstream sides of the liquid pumps 2a and 2b are connected to a mixer 14 which mixes the liquids flowing in both flow paths via a switching valve 12; the flow path of the liquid mixed by the mixer 14 is connected to a first analysis column 18 via an auto-sampler 16, which is a sample injection portion.

The flow amounts of the liquid pumps 2a and 2b may be selected appropriately according to the sample, first analysis column, and similar; the flow amounts of each of the liquid pumps may be constant, or may be varied independently with time. In the aspect shown in FIG. 1, the organic solvent 4a and water 4b comprised by the first mobile phase are sent by two liquid pumps and mixed by the mixer 14, and the first mobile phase is prepared with a prescribed composition and sent to the first analysis column 18; however, the organic solvent 4a and water 4b may be mixed at a prescribed ratio in advance and sent by a single liquid pump. The composition of the first mobile phase is also not limited to a liquid mixture of an organic solvent and water, but may be an organic solvent alone, or a liquid mixture of two kinds of organic solvents, and should be selected according to the sample and component thereof, analysis column, and similar. In order to facilitate separation of the component in the sample, a buffer solution in which a nonvolatile salt or other buffer is dissolved, or similar, may be used as a solvent comprised by the first mobile phase.

In this invention, a sample need only comprise a component which is to be concentrated, and may be taken to mean a sample in any form; in addition to a solution of the sample component itself and a drug formulation containing the sample component and similar, sample components in such media as blood, blood plasma, urine, and similar, are further examples.

As the first analysis column 18, a forward-phase column, reverse-phase column, ion exchange column, affinity column, gel permeation chromatography (GPC) column, or various other columns can be used, and may be selected accord to the component in the sample to be separated. No limits in particular are placed on the inner diameter or length of this analysis column.

On the downstream side of the first analysis column 18 is connected a PDA detector 20, which is the first detection device, so that the component in the sample which is separated in the first analysis column 18 is detected by the PDA detector 20. The PDA detector is a detector which continuously detects absorption spectra at wavelengths from the ultraviolet region (approximately 190 to approximately 400 nm) to the visible region (approximately 300 to approximately 800 nm), and is capable of acquiring the absorption spectrum of a sample separated in the first analysis column 18 at wavelengths from the ultraviolet region to the visible region. The detected absorption spectrum is stored in storage device (not shown).

In the liquid chromatograph shown in FIG. 1, a PDA detector is used; but in place of a PDA detector, an infrared detector (hereafter abbreviated to “IR detector”), a radioisotope detector (hereafter abbreviated to “RI detector”), or a fluorescence detector can be used. By using an IR detector when the concentrated component has a characteristic absorption spectrum in the infrared region, an RI detector when the concentrated component is a compound comprising a radioisotope, and a fluorescence detector when the concentrated component is labeled by a compound having fluorescence, the component can be identified reliably and more simply.

The PDA detector 20 is connected via a switching valve 22 to a fractionation flow path 24. The fractionation flow path 24 comprises a plurality of flow paths, in parallel and having isolation portions, between the two distribution valves 26a and 26b, and is connected to the switching valve 22 via the flow paths L9 and L10; the component concentrated in the first analysis column 18 is fractionated by the fractionation operation of the distribution valve, and the fractionated component is held together with the mobile phase in the isolation portions 25a to 25e. The switching valve 22 is also connected to a flow path L22 leading to a drain. In FIG. 1, five isolation portions are provided, but no limits are placed on the number of isolation portions.

Two flow paths L11 and L12 are connected between the switching valve 12 and the switching valve 22; one of the flow paths L11 branches midway and is connected to a trap flow path. The trap flow path is a flow path which sends components held in the isolation portions 25a to 25e to the trap column, causing capture and concentration of the component in the trap column; one trap column 30 is provided. The trap column 30 is connected to the switching valve 28 by the flow paths L16 and L17. The flow path L13 branching from the flow path L11 is connected to the switching valve 28, and at the switching valve 28 are provided the second analysis column 32, which separates the component captured and concentrated in the trap column 30, and a PDA detector 33, which is the second detection device for detecting the component separated by the second analysis column 32.

As the trap column 30, normally a column is used the inner diameter of which is smaller than the inner diameter of the first analysis column 18; although the dimension depends on the inner diameter of the first analysis column 18, normally a column of inner diameter 0.03 to 6 mm is used. As the trap column 30, for example, a packed-type column in which the interior of a cylindrical member is packed with a packing material, a monolith-type column, or similar can be used. When using a packed-type column as the trap column, it is preferable that a packed-type column be used in which a packing agent with particles of size 10 to 60 μm are packed is used, in order to reduce pressure within the trap column. No limits in particular are placed on the length of the trap column 30, but normally the length is approximately 10 to 100 mm.

As the second analysis column 32, from the standpoint of concentrating to an even higher concentration the component eluted from the trap column 30, it is preferable that for example a micro-column or nano-column or similar, with inner diameter from 0.03 to 0.3 mm, be used. The length of the second analysis column 32 is normally 10 to 30 cm.

The component eluted from the trap column 30 is detected by the PDA detector 33 which is the second detection device, and the absorption spectrum of the component at different wavelengths, from the ultraviolet region to the visible region, can be obtained. The detected absorption spectrum is stored in storage device (not shown), and by comparing the absorption spectrum detected by the PDA detector 20 and stored in the storage device with the absorption spectrum detected by the PDA detector 33, it is possible to judge whether the components are the same. Because the PDA detectors enable acquisition of the absorption spectrum at various wavelengths from the ultraviolet region to the visible region, more detailed spectral information can be obtained than in the case of an ultraviolet detector capable of acquiring the absorption spectrum at a single wavelength, and so component identification is facilitated.

The switching valve 28 is connected, via the mixer 40, to liquid pumps 36a and 36b used to supply the organic solvent 38a and water 38b comprised by the second mobile phase. An online degasser 39 is provided in the flow paths connecting the organic solvent 38a and water 38b with the liquid pumps 36a and 36b. The switching valve 28 is also connected to an exhaust flow path leading to a drain.

In order to facilitate elution of the component from the trap column 30, the second mobile phase may be determined according to the component and the trap column 30. Because the second mobile phase elutes the component which has been captured and concentrated in the trap column 30, a nonvolatile salt or other buffer or similar need not be used to improve separation of the component.

The first analysis column 18 and trap column 30 are provided within a column oven 41, and are held at a substantially constant temperature. In the aspect shown in FIG. 1, the first analysis column 18 and trap column 30 are provided in one column oven, but each column may be provided in a separate column oven. The second analysis column 32 is provided either in the column oven 41 or in a separate column oven, not shown, and is held at a substantially constant temperature.

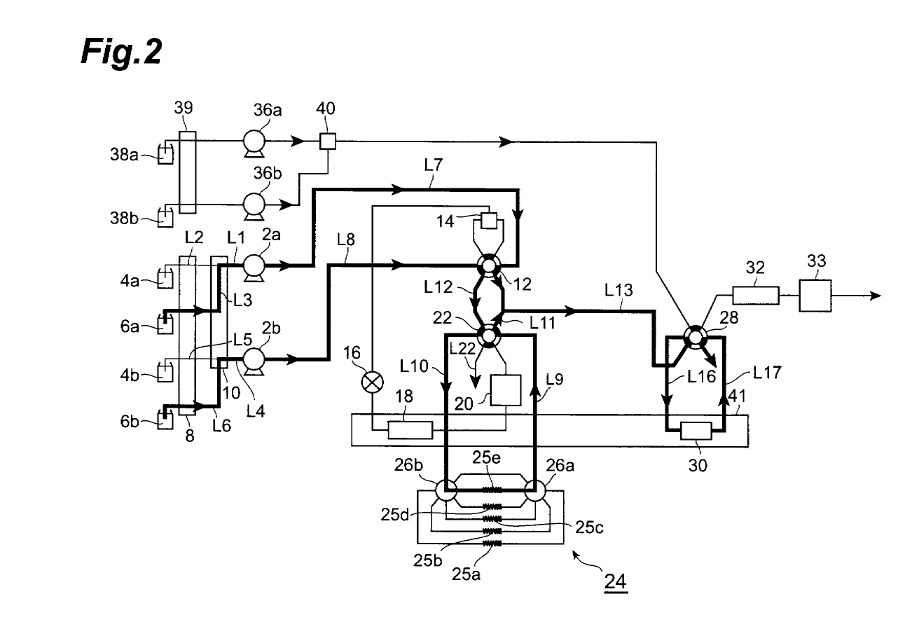

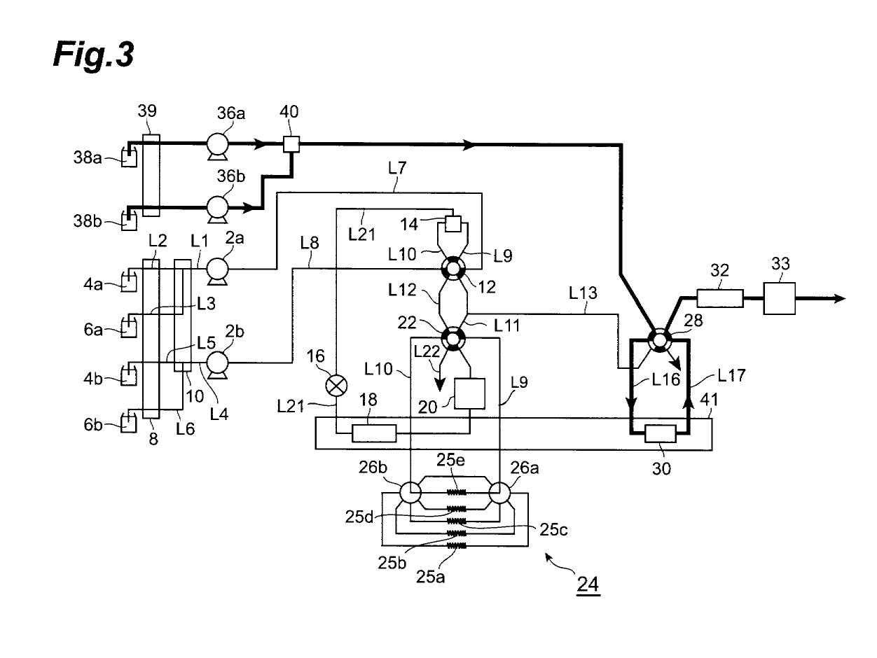

Next, operation of the liquid chromatograph of an aspect of the invention is explained. FIG. 1 shows a state in which a process of separation of the component in the sample and a process of fractionation of the separated component are being performed; the flow paths used in these processes are indicated by thick lines, and the flow of liquid is indicated by arrows. FIG. 2 shows a state in which a process of capture and concentration of the component in the trap column is being performed; similarly to FIG. 1, flow paths used in this process are indicated by thick lines, and the flow of liquid is indicated by arrows. FIG. 3 shows a state in which the component captured and concentrated in the trap column is being separated in the second analysis column; similarly to FIG. 1 and FIG. 2, flow paths used in this process are indicated by thick lines, and the flow of liquid is indicated by arrows.

First, the state of the process of separation of the component in the sample and the process of fractionation of the separated component is explained, based on FIG. 1.

Process of Separation of Component in Sample

The switching valve 10 is operated, so that flow path L1 and flow path L2 are connected, and in addition flow path L4 and flow path L5 are connected. When the liquid pumps 2a and 2b are started, the organic solvent 4a and water 4b are sent by the liquid pumps 2a and 2b respectively, passing through flow paths L7 and L8 respectively, and passing through the switching valve 12 to be mixed by the mixer 14, becoming the first mobile phase, which is sent via the auto-sampler 16 to the first analysis column 18. When the sample is injected from the auto-sampler 16, the injected sample is guided by the first mobile phase to the first analysis column 18, and the component in the sample is separated in the first analysis column 18.

Process of Fractionation of Separated Component

The separated component is eluted from the first analysis column 18, detected by the PDA detector 20, passes through the switching valve 22 and the flow path L9, and flows to the fractionation flow path 24. When the component is detected by the PDA detector 20, the distribution valves 26a and 26b operate according to the detection signal, one among the isolation portions 25a to 25e in the fractionation flow path 24 is selected, the separated component is fractionated, and the component fractionated in the selected isolation portion is held together with the first mobile phase. The spectrum detected by the PDA detector 20 is stored in storage device (not shown). In FIG. 1, the isolation portion 25e is selected, and the component is fractionated in isolation portion 25e. Each time a component is detected by the first detector 20 the distribution valves 26a and 26b are switched, one of the isolation portions in the fractionation flow path 24 is selected, fractionation operation is performed for each separated component, and the fractionated component is held, together with the first mobile phase, in the selected isolation portion. Material not held in an isolation portion of the fractionation flow path 24 by the first mobile phase flowing out from the first analysis column 18 passes through the distribution valve 26b, flow path L10, switching valve 22, and flow path L22, and is exhausted from a drain.

On the other hand, the liquid pumps 36a and 36b are started, and the organic solvent 38a and water 38b comprised by the second mobile phase are sent by the liquid pumps 36a and 36b respectively, and are mixed by the mixer 40 to become the second mobile phase, which passes through the switching valve 28, is sent to the trap column 30, and conditioning is performed.

Next, a state in which a process of capture and concentration of the component in the trap column is explained, based on FIG. 2.

Process of Capture and Concentration of Component in Trap Column

The switching valve 10 is operated, and the flow path L1 and flow path L3 are connected, and in addition the flow path L4 and flow path L6 are connected. The diluent 6a and carrier liquid 6b are sent by the liquid pumps 2a and 2b, and the carrier liquid 6b passes through the flow paths L6, L4 and L8, the switching valve 12, flow path L12, and the switching valve 22, and is guided to the flow path L10. The switching valves 26a and 26b are operated, one among the isolation portions in which is held the fractionated component is selected, and the carrier liquid 6b passes from the distribution valve 26b through the selected isolation portion, and together with the component and first mobile phase which had been held in the isolation portion, passes through the distribution valve 26a, flow path L9, switching valve 22, flow path L11, flow path L13, switching valve 28, and flow path L16, and is guided to the trap column 30. On the other hand, the diluent 6a passes through the flow paths L3, L1 and L7, the switching valve 12 and flow path L11, merges with the flow of the component and first mobile phase which had been held in the selected isolation portion and the carrier liquid 6b, and is guided to the trap column 30. Upon being guided to the trap column 30, the component is captured in the trap column 30 and is concentrated. After passing through the trap column 30, the first mobile phase, diluent 6a, and carrier liquid 6b pass through the flow path L17 and switching valve 28, and are exhausted from a drain.

Next, a state in which a process of separation by the second analysis column of the component which has been captured and concentrated by the trap column is explained, based on FIG. 3.

Process of Separation by Second Analysis Column of Component after Capture and Concentration in Trap Column

The organic solvent 38a and water 38b comprised by the second mobile phase pass through the online degasser 39, and with air bubbles removed, are then sent by the liquid pumps 36a and 36b respectively, and are mixed by the mixer 40 to become the second mobile phase, which passes through the switching valve 28 and flow path L16 and is guided to the trap column 30. In the trap column 30, the previously captured and concentrated component is eluted by the second mobile phase, and the eluted component together with the second mobile phase passes through the flow path L17 and switching valve 28 to be guided to the second analysis column 32, and is separated in the second analysis column 32. The separated component is detected by the PDA detector 33 which is the second detector, and the absorption spectrum is acquired. The acquired absorption spectrum is stored in storage device (not shown). By using a PDA detector, the absorption spectrum at arbitrary wavelengths from the ultraviolet region to the visible region can be acquired for each component, and by comparing the absorption spectrum detected and obtained by the PDA detector 20 with the absorption spectrum detected and obtained by the PDA detector 33, it is possible to judge, reliably and simply, whether the component separated in the first analysis column and concentrated in the trap column and the component separated in the second analysis column are the same. In place of a PDA detector, by using an IR detector, a RI detector, or a fluorescence detector, characteristic infrared absorption can be detected, or a compound containing a radioisotope or labeled with a compound having fluorescence can be detected, reliably and easily; because spectra can be compared, a judgment as to whether the component separated in the first analysis column and concentrated in the trap column and the component separated in the second analysis column are the same can be performed easily and reliably. In particular, instead of the combination of the PDA detector 20 and PDA detector 33, it is preferable that the combination of an infrared detector 20 and infrared detector 33, or the combination of a radioisotope detector 20 and a radioisotope detector 33, or the combination of a fluorescence detector 20 and a fluorescence detector 33, be adopted.

In FIG. 1 through FIG. 3, the component held in the isolation portions 25a to 25e within the fractionation flow path 24 is diluted by the diluent 6a and carrier liquid 6b and pressed out while being guided to the trap column 30; but the fractionated component may be held together with the carrier liquid 6b in the isolation portions 25a to 25e.

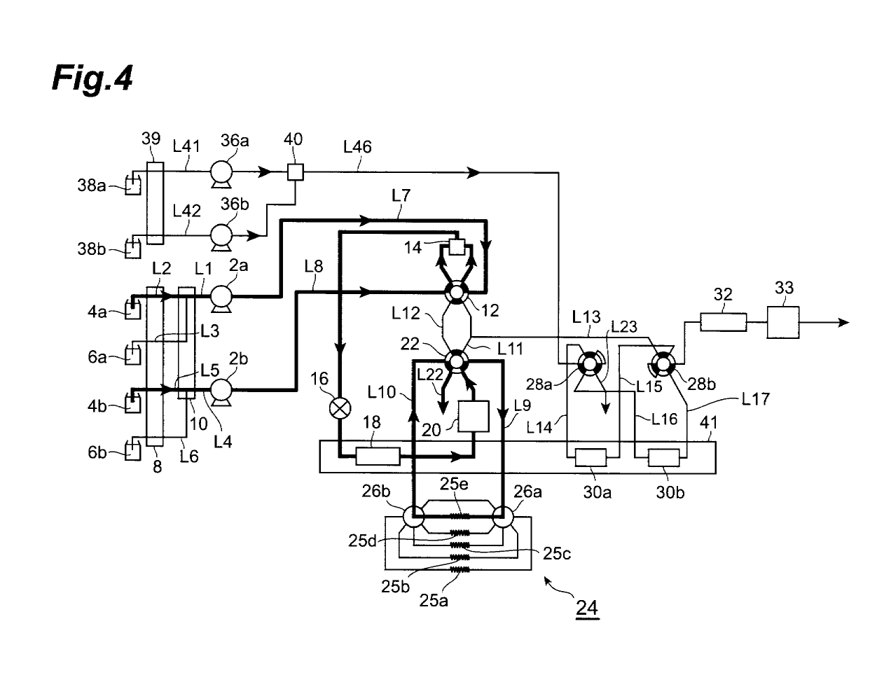

Next, operation of the liquid chromatograph of another aspect of the invention is explained, based on FIG. 4 through FIG. 6. The liquid chromatograph shown in FIG. 4 through FIG. 6 is a liquid chromatograph in which two trap columns are provided in parallel, together with a flow path switching mechanism. In the liquid chromatograph shown in FIG. 1, capture and concentration operations and component elution operations are performed in alternation by a single trap column, so that when complete elution is not possible and component remains in the trap column, there is the possibility of intermixing with the component which is next to be captured and concentrated, and so cases occur in which for example the time required for the component elution operation must be extended; but in the liquid chromatograph shown in FIG. 4, two trap columns are provided in parallel, so that the trap column in which the component is captured and concentrated can be alternated, and more efficient processing is possible.

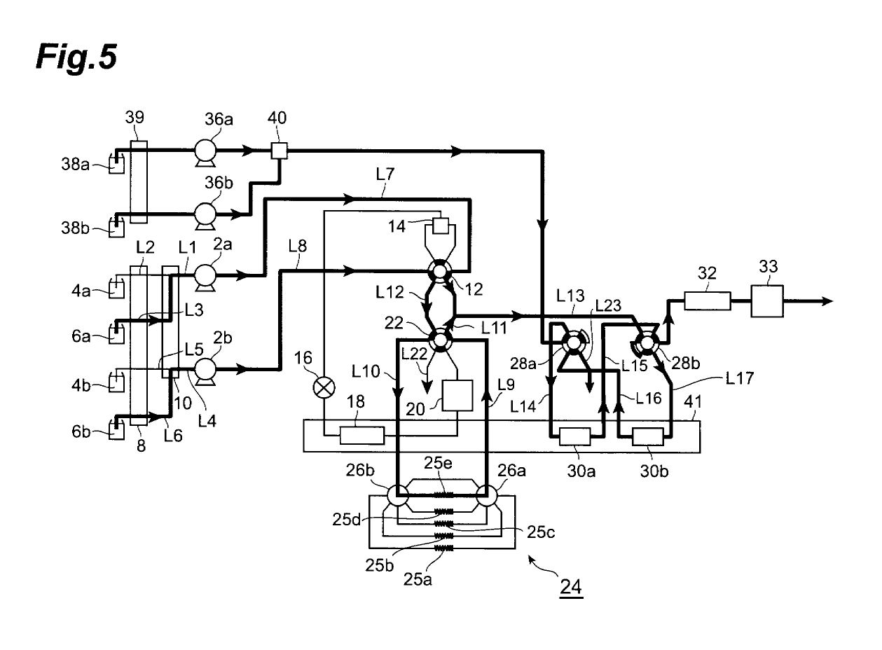

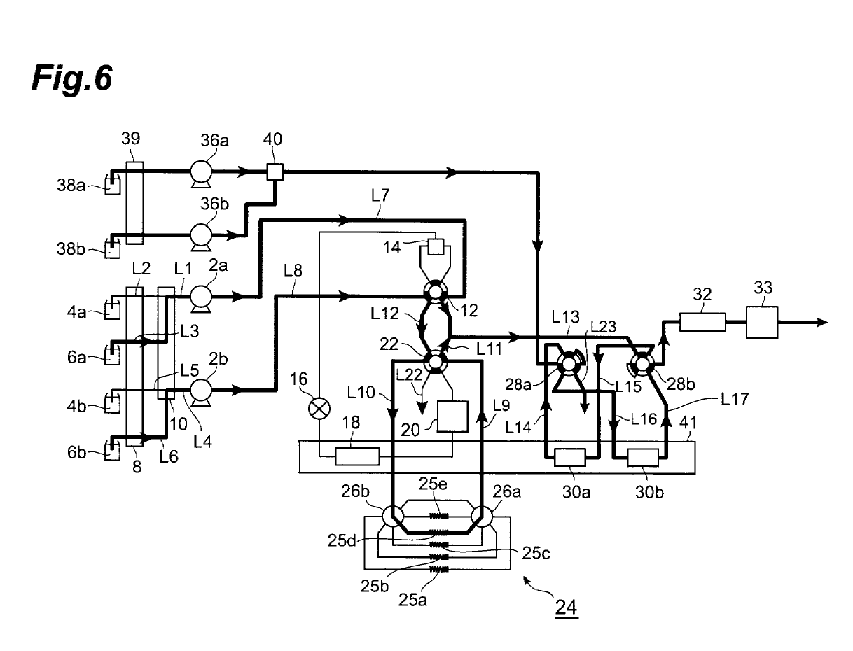

FIG. 4 shows a state in which a process of separation of the component in the sample and a process of fractionation of the separated component are being performed; the flow paths used in these processes are indicated by thick lines, and the flow of liquid is indicated by arrows. FIG. 5 and FIG. 6 show a state in which a process of capture and concentration of the component in the trap columns, and a process in which the component captured and concentrated in the trap columns is being eluted and in the second analysis column, are being performed simultaneously; flow paths used in these processes are indicated by thick lines, and the flow of liquid is indicated by arrows.

In the state in which the process of separation of the component in the sample and the process of fractionation of the separated component are being performed, shown in FIG. 4, operations similar to those explained for the state of FIG. 1 are performed.

Next, a state in which the process of capture and concentration of the component in another trap column, and a process of elution and retrieval of the component captured and concentrated in a trap column, are performed simultaneously is explained, based on FIG. 5.

Process of Capture and Concentration of Component in Trap Column

The switching valve 10 is operated, and the flow paths L1 and L3 are connected, and in addition the flow paths L4 and L6 are connected. The diluent 6a and carrier liquid 6b are sent by the liquid pumps 2a and 2b, and the carrier liquid 6b passes through the flow paths L6, L4 and L8, the switching valve 12, the flow path L12, and the switching valve 22, and is guided to the flow path L10. The distribution valves 26a and 26b are operated, and one among the isolation portions in which the fractionated component is held is selected; the carrier liquid 6b passes through the isolation portion selected by the distribution valve 26b, and together with the component and first mobile phase being held in the isolation portion, passes through the distribution valve 26a, flow path L9, switching valve 22, flow paths L11 and L13, switching valve 28b, and flow path L17, and is guided to the trap column 30b. On the other hand, the diluent 6a passes through the flow paths L3, L1 and L7, the switching valve 12, and the flow path L11, merges with the component which had been held by the selected isolation portion, the first mobile phase and the flow of carrier liquid 6b and is guided to the trap column 30b. The component guided to the trap column 30b is captured in the trap column 30b and concentrated. After passing through the trap column 30b, the first mobile phase, diluent 6a, and carrier liquid 6b pass through the flow path L16, switching valve 28a, and flow path L23, and are exhausted from a drain.

Process of Elution and Retrieval of the Component Captured and Concentrated in a Trap Column

On the other hand, the organic solvent 38a and water 38b comprised by the second mobile phase pass through the online degasser 39, and with air bubbles removed, are sent by the liquid pumps 36a and 36b respectively, and are mixed by the mixer 40 to become the second mobile phase, which passes through the switching valve 28a and flow path L14, to be guided to the trap column 30a. The component which has already been captured and concentrated in the trap column 30a is eluted by the second mobile phase, and the eluted component together with the second mobile phase pass through the flow path L15 and switching valve 28b, are guided to the second analysis column 32, and are separated in the second analysis column 32. The separated component is detected by the PDA detector 33 which is the second detector, and the absorption spectrum is acquired. The acquired absorption spectrum is stored in storage device (not shown). By using a PDA detector, the absorption spectrum can be acquired at arbitrary wavelengths from the ultraviolet region to the visible region for each component, and by comparing the absorption spectrum obtained by the PDA detector 20 with the absorption spectrum obtained by the PDA detector 33, a judgment can be made, easily and reliably, as to whether the component separated in the first analysis column and concentrated in a trap column is the same as the component separated in the second analysis column. In place of a PDA detector, by using an IR detector, a RI detector, or a fluorescence detector, characteristic infrared absorption can be detected, or a compound containing a radioisotope or labeled with a compound having fluorescence can be detected, reliably and easily; because spectra can be compared, a judgment as to whether the component separated in the first analysis column and concentrated in a trap column and the component separated in the second analysis column are the same can be performed easily and reliably. In particular, instead of the combination of the PDA detector 20 and PDA detector 33, it is preferable that the combination of an infrared detector 20 and an infrared detector 33, or the combination of a radioisotope detector 20 and a radioisotope detector 33, or the combination of a fluorescence detector 20 and a fluorescence detector 33, be adopted.

Next, a state in which the process of capture and concentration of the component in another trap column, and the process of elution of the component captured and concentrated in the trap column and of analysis in the second analysis column, are performed simultaneously is explained, based on FIG. 6.

When the process of elution of the component from the trap column 30a and the process of capture and concentration of the component in the trap column 30b, shown in FIG. 5, are completed, then the distribution valves 26a and 26b are switched, and another isolation portion 25d in which a fractionated component is being held is selected, as shown in FIG. 6. The switching valves 28a and 28b are switched, and the component held in the isolation portion 25d passes, together with the first mobile phase, diluent 6a and carrier liquid 6b, through the switching valve 28b and flow path L15, to be guided to the trap column 30a, and in the trap column 30a the component is captured and concentrated. On the other hand, the component which had been captured and concentrated in the trap column 30b is eluted by the second mobile phase which has passed through the switching valve 28a and flow path L16, and the eluted component together with the second mobile phase pass through the flow path L17 and switching valve 28b and are guided to the second analysis column 32, and are separated in the second analysis column 32. The separated component is detected by the PDA detector 33 which is the second detector, and the absorption spectrum is acquired. The acquired absorption spectrum is stored in storage device (not shown). By using a PDA detector, the absorption spectrum at arbitrary wavelengths from the ultraviolet region to the visible region can be acquired for each component, and by comparing the absorption spectrum detected and obtained by the PDA detector 20 with the absorption spectrum detected and obtained by the PDA detector 33, it is possible to judge, reliably and simply, whether the component separated in the first analysis column and concentrated in a trap column and the component separated in the second analysis column are the same.

Thus in the liquid chromatograph shown in FIG. 4 through FIG. 6, not only can a judgment be made reliably and easily as to whether the component separated in the first analysis column and concentrated in a trap column is the same as the component separated in the second analysis column, but a plurality of trap columns are provided, and a flow path switching mechanism is comprised, to enable simultaneous performance of a capture/concentration operation to capture and concentrate the component in one trap column of the trap flow path and an elution operation to cause elution of the captured component from another trap column; hence an operation of elution of the component captured and concentrated in one trap column can be performed simultaneously, or continuously, with an operation of capture and concentration of the component in another trap column, so that processing efficiency is improved.

Further, compared with a sample injected from the auto-sampler 16, the component analyzed in the second analysis column is in a concentrated state, and so even when only a slight amount of the component is comprised by a sample, the component analyzed in the second analysis column can be analyzed by for example mass spectrometry, NMR or other methods to acquire high-sensitivity data, to further improve measurement efficiency. Moreover, when a first mobile phase comprising a nonvolatile salt or other buffer is used, by using a diluent and carrier liquid not comprising a nonvolatile salt or other buffer, desalination processing can be performed simultaneously, and so an analysis sample can be prepared which effectively does not contain a nonvolatile salt or other buffer, and which is suitable for mass spectrometry or other methods which are easily affected by such nonvolatile salts. Hence a mass spectrometry device or nuclear magnetic resonance device can be connected behind the PDA detector 33 to perform online analysis.

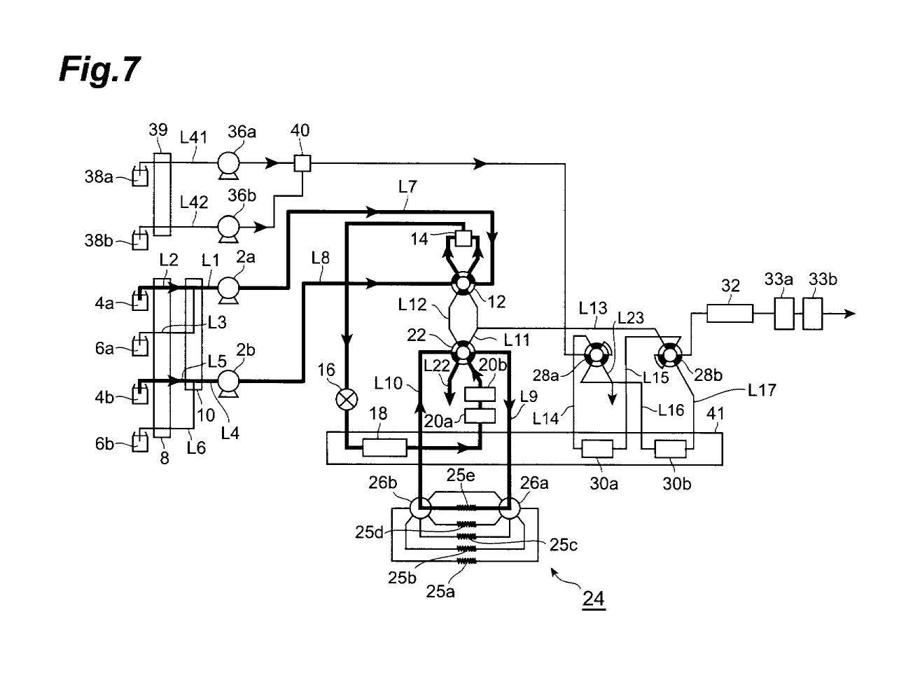

Next, the liquid chromatograph of still another aspect of the invention is explained, based on FIG. 7 through FIG. 9. Similarly to the liquid chromatograph shown in FIG. 4 through FIG. 6, the liquid chromatograph shown in FIG. 7 through FIG. 9 is provided with two trap columns in parallel, as well as a flow path switching mechanism; in addition, as the first detection device, two types of detector, which are a UV detector 20a and an IR detector 20b, are provided, and as the second detection device, two types of detector, which are a UV detector 33a and an IR detector 33b, are provided. In such a liquid chromatograph, in which the first and second detection devices each comprise at least two types of detector, one type of which is a UV detector, and the other type of which is a PDA detector, an IR detector, an RI detector, or a fluorescence detector, component identification is performed using two types of detector, so that a larger amount of information can be obtained, and more reliable component identification is possible. In particular, in place of the combination of an IR detector 20b and an IR detector 33b, it is preferable that the combination of a PDA detector 20b and a PDA detector 33b, or the combination of a radioisotope detector 20b and a radioisotope detector 33b, or the combination of a fluorescence detector 20b and a fluorescence detector 33b, be adopted.

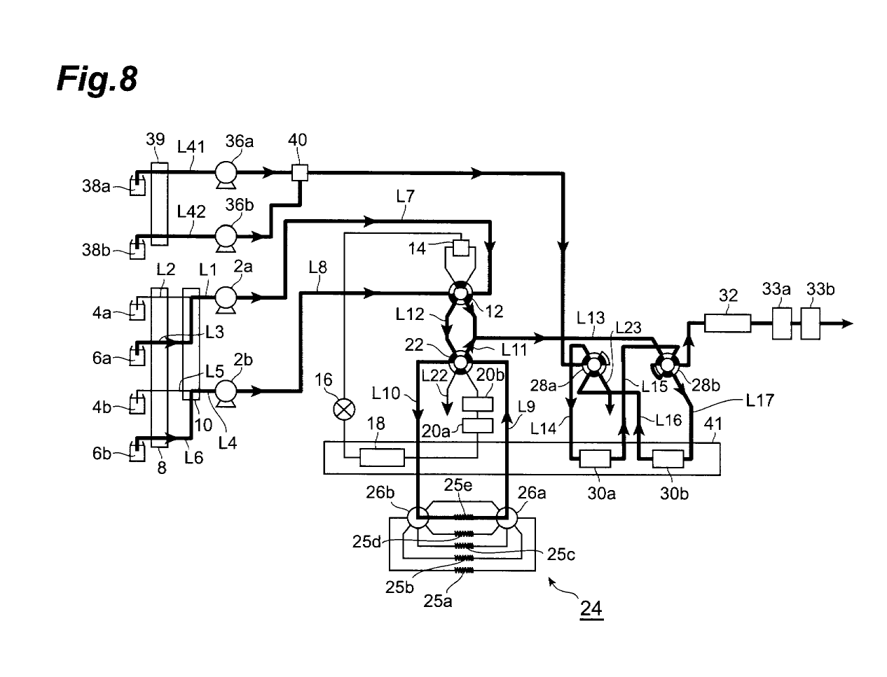

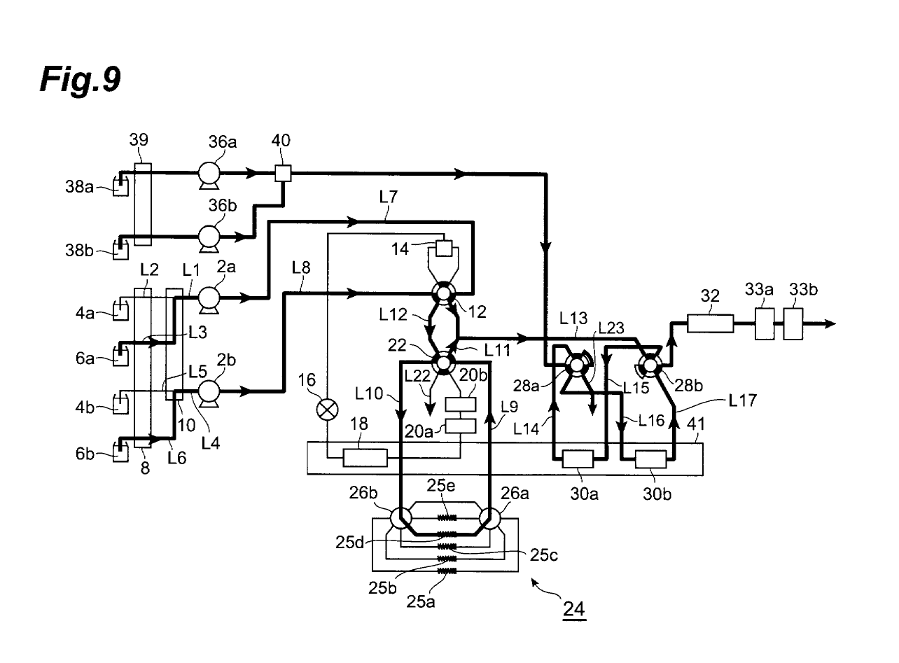

FIG. 7 shows a state in which a process of separation of the component in the sample and a process of fractionation of the separated component are being performed; the flow paths used in these processes are indicated by thick lines, and the flow of liquid is indicated by arrows. FIG. 8 and FIG. 9 show a state in which a process of capture and concentration of the component in a trap column and a process of elution of the component captured and concentrated in a trap column and of analysis in the second analysis column are being performed simultaneously; the flow paths used in these processes are indicated by thick lines, and the flow of liquid is indicated by arrows. In the state shown in FIG. 7 in which the process of separation of the component in the sample and the process of fractionation of the separated component are being performed, operations similar to those explained with respect to the states shown in FIG. 1 and FIG. 4 are performed, and UV spectra and IR spectra can be acquired for each component. In the states shown in FIG. 8 and FIG. 9 in which the process of capture and concentration of the component in a trap column and the process of elution of the component captured and concentrated in a trap column and of analysis in the second analysis column are performed simultaneously, operations similar to those explained with respect to the states shown in FIG. 2 and FIG. 3 and in FIG. 5 and FIG. 6 are performed, and UV spectra and IR spectra are acquired for each of the captured and concentrated components; the UV spectra and IR spectra acquired by the first detection device are compared with the UV spectra and IR spectra acquired by the second detection device, and component identification is performed.

In the aspects shown in FIG. 4 through FIG. 9, two trap columns are provided in parallel; but two parallel sets of a plurality of trap columns can also be provided. By this means, the capture/concentration operation of capturing and concentrating the component in one trap column of the trap flow path, and the elution operation of causing elution of the component captured in another trap column, can be performed simultaneously.

Further, in the aspects shown in FIG. 1 through FIG. 9, a switching valve 10 is provided, and liquid pumps 2a and 2b are used to switch the propulsion of the organic solvent 4a and water 4b comprised by the first mobile phase and the diluent 6a and carrier liquid 6b, which pass through the same flow path and are sent to the fractionation flow path 24; however, by providing a separate liquid pump to send the diluent 6a and carrier liquid 6b, and causing the diluent 6a and carrier liquid 6b to pass through a flow path different from the flow path through which the organic solvent 4a and water 4b comprised by the first mobile phase flow, to be sent to the fractionation flow path 24, the process of separation of the component in the sample and fractionation of the separated component and the process of elution and retrieval of the component, or the process of analysis of the component in the second analysis column and the process of capture and concentration of the component in a trap column and of elution and retrieval of the concentrated component or of analysis in the second analysis column, can be performed simultaneously.

1. A liquid chromatograph, comprising:
a first analysis column, which separates a component in a sample guided by a first mobile phase;
first detection device for detection of the component;
a fractionation flow path, which fractionates and holds in an isolation portion the component detected by the first detection device;
a trap flow path, which sends the component held in the isolation portion into a trap column, and causes capture and concentration of the component in the trap column;
a second analysis column, which separates the component which has been captured and concentrated in the trap column and is eluted from the trap column by a second mobile phase; and
second detection device for detection of the component separated in the second analysis column,
wherein the first and second detection devices have a detector selected from a group consisting of a photodiode array detector, an infrared detector, a radioisotope detector, and a fluorescence detector.

2. The liquid chromatograph according to claim 1, provided with a plurality of the trap columns,
and further comprising a flow path switching mechanism for simultaneously performing a capture/concentration operation of causing capture and concentration of the component in one trap column of the trap flow path, and an elution operation of causing elution of the component captured in another trap column.

3. The liquid chromatograph according to claim 1, wherein the first and second detection devices each further have an ultraviolet detector.

4. The liquid chromatograph according to claim 1, wherein the component held in an isolation portion is sent to the trap column while being diluted by a diluent.

5. The liquid chromatograph according to claim 1, wherein the component separated in the first analysis column is fractionated, and is held together with diluent in an isolation portion.

6. The liquid chromatograph according to claim 2, wherein the first and second detection devices each further have an ultraviolet detector.

7. The liquid chromatograph according to claim 2, wherein the component held in an isolation portion is sent to the trap column while being diluted by a diluent.

8. The liquid chromatograph according to claim 2, wherein the component separated in the first analysis column is fractionated, and is held together with diluent in an isolation portion.
